(19) United States
(12) Patent Application Publication
(10) Pub. No.: US 2010/0238921 A1
(43) Pub. Date: Sep. 23, 2010

(54) COMMUNICATION APPARATUS, ITS OPERATING METHOD, AND OPERATING PROGRAM

(75) Inventors: Shuuichi Karino, Tokyo (JP); Masahiro Jibiki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/159,566

(22) PCT Filed: Dec. 26, 2006
(86) PCT No.: PCT/JP2006/325881

§ 371 Date: Jun. 27, 2008

(30) Foreign Application Priority Data
Dec. 28, 2005 (JP) 2005-377591

(51) Int. Cl. H04L 12/56; G06F 9/50

(52) U.S. Cl. 370/389; 719/328

(57) ABSTRACT

An object of the present invention is to provide a communication apparatus capable of connecting required modules for use in protocol processing depending on a packet to be processed without previous setting of the execution order of the modules so as to perform packet processing. A communication apparatus retains meta-information for each module implementing a protocol and a calculating means (transmission path restriction calculating section) for calculating module connection order based on the meta-information and a packet to be processed. The meta-information includes: the type of services that each module can provide on a protocol stack; a rule according to which it is determined whether each module can execute processing of a packet to be processed; and module information on a result of the determination of whether or not each module can execute the processing of a packet to be processed. The calculating means determines, according to the rule, whether each module can perform processing of a packet to be processed, attaches the information concerning the type of services to the packet to be processed, and outputs the connection order of modules by which the entire portion of the packet can be processed while acquiring the meta information from the packet.

### TECHNICAL FIELD

The present invention relates to a communication apparatus for relaying packets and terminating a protocol, its operating method, and operating program and, more particularly, to a communication apparatus in which software for processing packets and the like is implemented in a component-based manner and its communication software configuration method.

### BACKGROUND ART

Conventionally, communication software used in a communication apparatus of such a type has been implemented in a package. That is, it has not been assumed that a part of the software is removed for replacement with another implementation or that another software providing additional communication function is implemented without consciousness of the configuration of the software that has already been implemented.

In recent years, communication functions become diversified and thereby communication software becomes increasingly complex. Further, the time to be taken for software development becomes shorter. Under such circumstances, component-based software, it has been demanded that components are individually developed in units of function and one software is realized by combining the individual components.

For example, “STREAMS” disclosed in Non-patent document 1 adopts a configuration in which data transmission/reception processing is defined by a plurality of layers and interfaces between respective layers are defined so that the processing in the respective layer can individually be implemented as modules. Further, in this configuration, connection order of the respective layers are not fixed but freely determined by applications.

With the above configuration, by dividing complicated protocol processing into modules for implementation, the complexity of each module can be reduced. Further, by replacing only a specific module with another one, enhancement or update of functions can be achieved without changing the entire configuration of the system.

Further, “click modular router” disclosed in Non-patent document 2 has a configuration in which modules individuated in a finer-grained manner can be combined.

According to this document, implementation of each component of communication software can be made by making it possible to write the component in an object-oriented language, declaring each interface in the base class so as to specify the configuration of the component, and expanding the specified configuration. Further, a language describing the connection between components to represent a node is defined, so that the node can easily be configured by connecting the components.

Non-Patent Document 1: Uresh Vahalia (translated by Hideyuki Tokuda and three others) “Kernel of the most advanced UNIX®” Chapter 17 STREAMS, published by Pearson Education Japan in May 15, 2000, pp. 643-690

Non-Patent Document 2: Robert Morris and three others “The Click Modular Router”, In Proceedings of the 17th ACM Symposium on Operating Systems Principles (SOSP' 99) (USA), December 1999, pp. 217-231

### DISCLOSURE OF THE INVENTION

### Problems to be Solved by the Invention

In a conventional approach, the connection order of modules used for performing protocol processing needs to be previously set, so that it takes time and effort to manage modules whose configuration are complicated and are likely to dynamically change. For example, in the case where a module of a given protocol is updated for correction of a malfunction or function enhancement, it is necessary to remove the current module and perform a connection of a new module.

The above system has the following restrictions:

(1) Application or set-up program needs to explicitly perform connection change processing.

(2) Packet processing must be stopped during the connection change processing.

An object of the present invention is to provide a communication apparatus capable of automatically connecting required modules for use in protocol processing depending on a packet to be processed without previous setting of the execution order of the modules so as to perform packet processing.

### Means for Solving the Problems

To achieve the above object, according to a first aspect of the present invention, there is provided a communication apparatus allowing a computer to execute network protocol software constituted by a set of a plurality of modules that perform protocol processing, characterized by comprising: a meta-information retaining means for retaining predetermined meta-information for each module implementing a protocol; and a calculating means for calculating connection order of the modules based on the meta-information and a packet to be processed.

The meta-information may include: the type of services that each module can provide on a protocol stack; a rule according to which it is determined whether each module can execute processing of a packet to be processed; and module information on a result of the determination of whether or not each module can execute the processing of a packet to be processed, which is necessary for such determination, and the calculating means may determine, according to the rule whether each module can perform processing of a packet to be processed, attach the information concerning the type of services to the packet to be processed, and output the connection order of modules by which the entire portion of the packet can be processed while acquiring the module information from the packet.

According to a second aspect of the present invention, there is provided a communication apparatus allowing a computer to execute network protocol software constituted by a set of a plurality of modules that perform protocol processing, characterized by comprising: a means for individually retaining predetermined meta-information of respective modules; a means for determining the packet processing order between the plurality of modules based on a packet to be processed and meta-information individually retained in the plurality of modules; a means for attaching the information concerning the determined packet processing order to the packet; and a means for allowing each module to determine a transmission destination of the packet based on the information concerning the packet execution order which has been attached to the packet.

The communication apparatus may further include: a means for determining whether each module can process at least the header information of the packet based on the packet and meta-information individually retained in the respective modules; a means for identifying the modules that can process at least the header information of the packet and attaching to the packet information in which the identification information of the identified modules are sequentially connected as information indicating packet processing order; and a means for passing the packet to the next identified module according to the order that the information attached to the packet indicates so as to allow the module to perform processing of the packet.

The communication apparatus may further include: application software that performs communication via the plurality of modules; a transmission application program interface (API) and reception application program interface (API) connected between the plurality of modules and application software; and a means for calling means for determining the packet processing order between the transmission API and plurality of modules.

The communication apparatus may further include: a means for performing communication with a module repository in which the plurality of modules are stored; a means for retaining only the meta-information of the plurality of modules in a separated manner from the plurality of modules; a means for acquiring, when it has been determined that one module of the plurality of modules is needed for packet processing, the one module from the module repository; and a means for deleting a no longer required module from the communication apparatus.

The communication apparatus may further include: a means for storing and retaining information of the packet processing order between the plurality of modules in a cache; and a means for searching information of the cache so as to determine the packet processing order between the plurality of modules.

The communication apparatus may further include: a means for detecting, in the case where the module stored in the module repository is updated, the update of the module; and a means for acquiring a module after update at the time of update of the module and applying the module after update to a new session while applying a module before update to the existing session that the module before update is currently processing.

Further, according to a third aspect of the present invention, there is provided an operating method of a communication apparatus allowing a computer to execute network protocol software constituted by a set of a plurality of modules that perform protocol processing, characterized by comprising the steps of: individually retaining predetermined meta-information of respective modules; determining the packet processing order between the plurality of modules based on a packet to be processed and meta-information individually retained in the plurality of modules; attaching the information concerning the determined packet processing order to the packet; and allowing each module to determine a transmission destination of the packet based on the information concerning the packet execution order which has been attached to the packet.

Further, according to a fourth aspect of the present invention, there is provided an operation program of a communication apparatus allowing a computer to execute network protocol software constituted by a set of a plurality of modules that perform protocol processing, the program allowing the computer to execute the steps of: individually retaining predetermined meta-information of respective modules; determining the packet processing order between the plurality of modules based on a packet to be processed and meta-information individually retained in the plurality of modules; attaching the information concerning the determined packet processing order to the packet; and allowing each module to determine a transmission destination of the packet based on the information concerning the packet execution order which has been attached to the packet.

### ADVANTAGES OF THE INVENTION

According to the present invention, it is possible to provide a communication apparatus capable of automatically connecting required modules for use in protocol processing depending on a packet to be processed without previous setting of the execution order of the modules so as to perform packet processing.

### BRIEF DESCRIPTION OF THE DRAWINGS

FIG. 1 is a block diagram showing the entire configuration of a communication apparatus according to a first example of the present invention;

FIG. 2 is a view for explaining a description (definition) example of meta-information of an Ethernet frame reception processing module in the first example;

FIG. 3 is a view for explaining a description (definition) example of meta-information of an IPv4 packet reception processing module in the first example;

FIG. 4 is a view for explaining a description (definition) example of meta-information of a UDP datagram reception processing module in the first example;

FIG. 5 is a view for explaining an Ethernet frame containing a sample packet in the case where the meta-information of the protocol modules shown in FIGS. 2 to 4 are used to perform transmission path calculation;

FIG. 6 is a view for explaining an Ethernet frame whose data area is divided into protocol headers and payload;

FIG. 7 is a view explaining meta-data which is added to receiving data by a packet receiving section in the case where the meta-information of the protocol modules shown in FIGS. 2 to 4 are used to perform transmission path calculation;

FIG. 8 is a view for explaining meta-information which is added to receiving data by using the meta-information of the Ethernet frame reception processing module shown in FIG. 2;

FIG. 9 is a view for explaining meta-information which is added to receiving data by using the meta-information of the IP packet reception processing module shown in FIG. 3;

FIG. 10 is a view for explaining meta-information which is added to receiving data by using the meta-information of the UDP datagram reception processing module shown in FIG. 4;

FIG. 11 is a view for explaining module connection order obtained as a result of transmission path calculation which is performed by using the meta-information of the protocol modules shown in FIGS. 2 to 4;

FIG. 12 is a view for explaining receiving data which is passed to the IPv4 packet reception processing module in the case where protocol processing is performed by the IPv4 packet reception processing module in the first example;

FIG. 13 is a block diagram showing the entire configuration of a communication apparatus according to a second example of the present invention;

FIG. 14 is a view for explaining data prepared by an application in the case where the communication apparatus performs UDP transmission processing in the second example;

FIG. 15 is a view for explaining a transmission context in the case where the communication apparatus performs UDP transmission processing in the second example;

FIG. 16 is a view for explaining meta-data which is added to transmission data in the UDP transmission processing performed by the communication apparatus in the second example;

FIG. 17 is a block diagram showing the entire configuration of a communication apparatus according to a third example of the present invention; and

FIG. 18 is a block diagram showing the entire configuration of a communication apparatus according to a fourth example of the present invention.

### EXPLANATION OF REFERENCE SYMBOLS

100, 200, 400: Communication apparatus
110-1, . . . , 110-x, 210-1, . . . , 210-x, 410-1, . . . , 410-x: Packet receiving section
120, 230, 420: Module retrieval information imparting section
130, 240, 430: Transmission path restriction calculating section
140-1, . . . , 140-n, 250-1, . . . , 250-n, 310-1, . . . , 310-n, 440-1, . . . , 440-n: Protocol module
141, 441: Next module retrieving section
142, 442: Meta-information retaining section
150-1, . . . , 150-y, 220-1, . . . , 220-y, 450-1, . . . , 450-y: Packet transmitting section
260-1, . . . , 250-p: Transmission API
270-1, . . . , 270-q: Reception API
270-1, . . . , 250-r: Application
300: Module repository
330: Module retrieving section
431: Transmission path high-speed retrieving section
432: Transmission path cache

### DESCRIPTION OF EXEMPLARY EMBODIMENTS

Exemplary embodiments of the present invention will be described in greater detail by referring to the accompanying drawings.

A communication apparatus according to the present exemplary embodiment adopts a configuration including a meta-information retaining means for retaining predetermined meta-information for each module implementing a protocol and a calculating means for calculating module connection order based on the meta-information and a packet to be processed. The meta-information includes the following information for each module: (1) type of the services that each module can provide on a protocol stack; (2) rule according to which it is determined whether each module can execute processing of a packet to be processed; and (3) module information on a result of the determination of whether or not each module can execute the processing of a packet to be processed, which is necessary for such determination.

In this configuration, the calculating means determines, according to the rule of (2) whether each module can perform processing of a packet to be processed, adds the information of (1) to the packet to be processed, and outputs the connection order of modules by which the entire portion of the packet can be processed while acquiring the information of (3) from the packet.

This makes it possible to provide a communication apparatus (packet processing apparatus) having a mechanism capable of adequately connecting modules depending on a packet to be processed without the need of previously setting module connection order. The reason is as follows: since a given module retains feature information of a module to be positioned before the given module, feature information to be supplied to a module to be positioned after the given module, and feature information of a packet that the given module can processed, module connection order satisfying all the feature information can be determined from an input packet.

Further, according to the present exemplary embodiment, non-modular software can be utilized as a part of the communication apparatus. The reason is as follows: a send/receive API (Application Program Interface) is provided between a protocol module and other software, and a modularized configuration of the protocol portion is hidden from the other software.

Further, according to the present exemplary embodiment, it is possible to provide a communication apparatus (processing apparatus) that effectively utilizes resources by automatically adding/deleting a module to/from the apparatus so as to perform update/addition of a function. This is because resources are not wasted by the following features.

(1) A module required for processing of an incoming packet can be acquired via a network.

(2) By deleting a module no longer required from the apparatus, required modules can always be retained so as to respond to incoming packets.

(3) A module unnecessary for packet processing can be deleted.

Further, according to the present exemplary embodiment, it is possible to provide a communication apparatus capable of performing protocol processing at high speed. The reason is as follows: the execution order of modules to be applied to the first packet of a sequence of packets following a set pattern (e.g., belonging to a given flow) is retained in a cache and the module execution order with respect to the second and subsequent packets are determined according to the retained information in the cache, so that processing content can determined at high speed.

Further, according to the present exemplary embodiment, it is possible to provide a communication apparatus capable of updating a module without processing interruption and without previous setting. The reason is as follows. Functions of communication apparatuses according to the third and fourth exemplary embodiments are used to automatically acquire a module whose function has been updated and retain the execution order of modules in a cache such that a module before update processes a packet of a flow starting before the function of the module is updated while a module after update processes a packet of a flow starting after the function of the module has been updated. Thus, the execution order of modules can be changed such that packet processing is performed by a new module without processing interruption in both the flows.

Examples of the present invention will be described below with reference to the accompanying drawings.

### Example 1

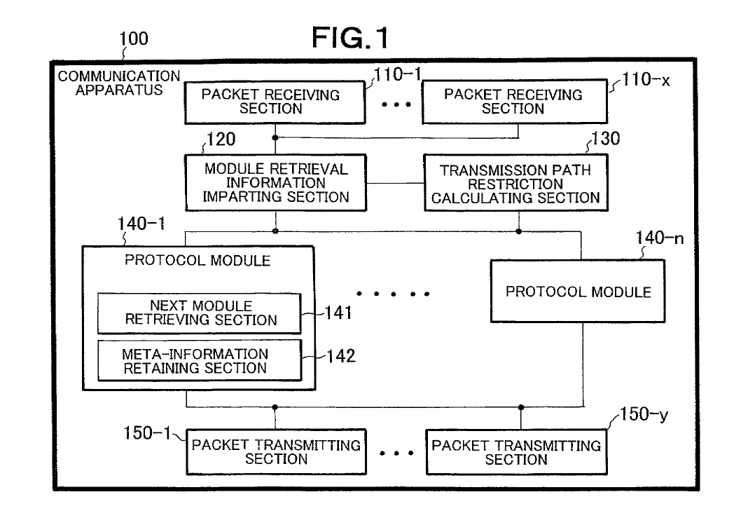

FIG. 1 is a block diagram showing a configuration of a first example of the present invention.

Referring to FIG. 1, a communication apparatus 100 according to the present example functionally includes one or more packet receiving sections 110-1, . . . , 110-x, a module retrieval information imparting section 120, a transmission path restriction calculating section 130, one or more protocol modules (hereinafter, abbreviated as “module”) 140-1, . . . , 140-n, and one or more packet transmitting sections 150-1, . . . , 150-y.

The packet receiving sections 110-1, . . . , 110-x are connected to the module retrieval information imparting section 120. The module retrieval information imparting section 120 is connected to the transmission path restriction calculating section 130 and modules 140-1, . . . , 140-n. The transmission path restriction calculating section 130 is further connected to the modules 140-1, . . . , 140-x. The modules 140-1, . . . , 140-n are further connected to the packet transmitting sections 150-1, . . . , 150-x.

The packet receiving sections 110-1, . . . , 110-x each serve as an interface between outside of the apparatus 100 and communication software realized by the configuration of the present example and have a function of passing data of a reception packet (hereinafter, referred to as “reception data”) to the module retrieval information imparting section 120.

The packet transmitting sections 150-1, . . . , 150-y each serve as an interface between outside of the apparatus 100 and communication software realized by the configuration of the present example and have a function of transmitting transmission data (hereinafter, referred to as “transmission packet”) that the modules 140-1, . . . , 140-n create for another apparatus to outside of the apparatus 100.

The modules 140-1, . . . , 140-n each are a software component implementing a specific communication protocol and configured to process received data and create transmission data to be transmitted to another communication apparatus. The communication protocol is constituted by processing modules corresponding respectively to seven layers: physical layer, data link layer, network layer, transport layer, session layer, presentation layer, and application layer (in the order of the lowest layer to the highest layer) of the OSI (Open Systems Interconnection) reference model in which a communication function to be provided in, e.g., a computer is divided into seven layers as described above. Alternatively, the communication protocol is constituted by processing modules corresponding respectively to four layers: network interface layer, Internet layer, transport layer, and application layer (in the order of the lowest layer to the highest layer) of TCP/IP (Internet Protocol/Transmission Control Protocol) protocols constructed based on the OSI reference model. There are provided Ethernet® and the like as the processing modules of the physical layer and data link layer (network interface layer), IP (Internet Protocol) and the like as the processing modules of the network layer (Internet layer), UDP (User Diagram Protocol), TCP (Transmission Control Protocol), and the like as the processing modules of the transport layer. The modules 140-1, . . . , 140-n according to the present example are implemented as the processing modules such as Ethernet, IP, and UDP corresponding to these communication protocols.

The module retrieval information imparting section 120 provides information (module retrieval information) for retrieving a module required for processing reception data to the reception data according to a predetermined procedure.

The transmission path restriction calculating section 130 determines modules 140-1, . . . , 140-n required for processing the reception data and execution order thereof based on the reception data and meta-information of the modules 140-1, . . . , 140-n.

The modules 140-1, . . . , 140-n each functionally include a protocol processing section (not shown), a next module retrieving section 141, and a meta-information retaining section 142.

The protocol processing section processes the reception data passed from the module retrieval information imparting section 120 or other modules 140-1, . . . , 140-n according to a protocol implemented in corresponding modules 140-1, . . . , 140-n.

The next module retrieving section 141 has a function of determining a next module 140-1, . . . , 140-n to be executed for the reception data based on the module retrieval information attached to the reception data and passing the resultant data to the determined next module 140-1, . . . , 140-n.

The meta-information retaining section 142 retains the meta-information of the modules 140-1, . . . , 140-n. The meta-information includes the feature information of the modules 140-1, . . . , 140-n, such as the type of reception data that the modules 140-1, . . . , 140-n can process, a precondition required for the modules 140-1, . . . , 140-n to process the reception data, a change made to the reception data by the processing performed by the modules 140-1, . . . , 140-n.

More specifically, the meta-information retained in the meta-information retaining section 142 includes the following information.

(1) The meta information includes a condition (execution module determination condition) according to which it is determined whether modules 140-1, . . . , 140-n can execute processing of the reception data. In the case of, e.g., IPv4 reception processing, the meta-information includes conditions for use in determining whether or not the first four bits are 0010, determining for each lower layer whether or not the upper layer of the corresponding layer is IP, determining whether or not the protocol number is 0x0800 in the case whether the lower layer is Ethernet, determining whether or not the protocol number is 4 in the case where the upper layer is IP-in-IP, determining whether or not an IP header checksum is a correct value.

(2) The meta information includes meta-information required for the processing performed by the modules 140-1, . . . , 140-n which have been attached to the reception data. In the case of, e.g., the IPv4 reception processing, the meta information includes offset information indicating the position of the header of the lower layer.

(3) The meta information includes meta-information which will be attached to the reception data after the reception data is processed by the modules 140-1, . . . , 140-n. In the case of, e.g., IPv4 reception processing, the meta-information includes the protocol number of the next layer and IP header length.

(4) The meta information includes meta information useful for identifying the modules 140-1, . . . , 140-n. Examples of this include creation date and creator of the modules 140-1, . . . , 140-n, and URL (Uniform Resource Locator) of the distribution source of the modules 140-1, . . . , 140-n.

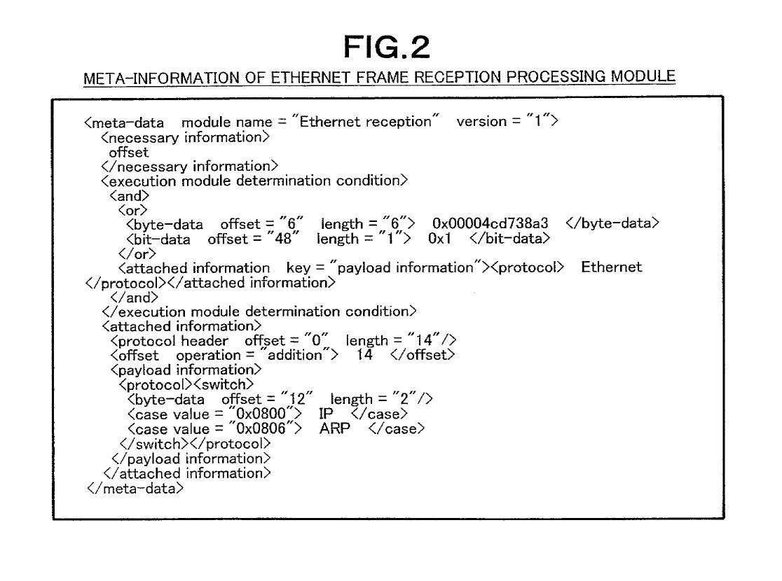

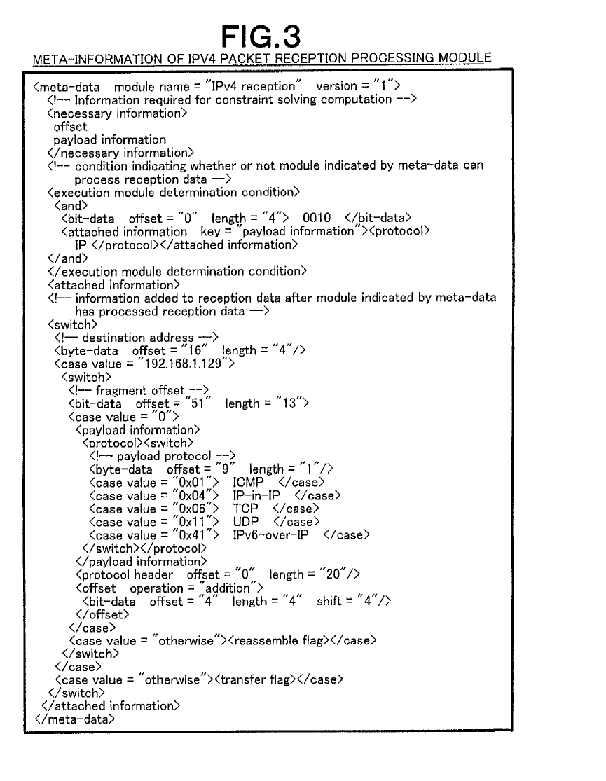

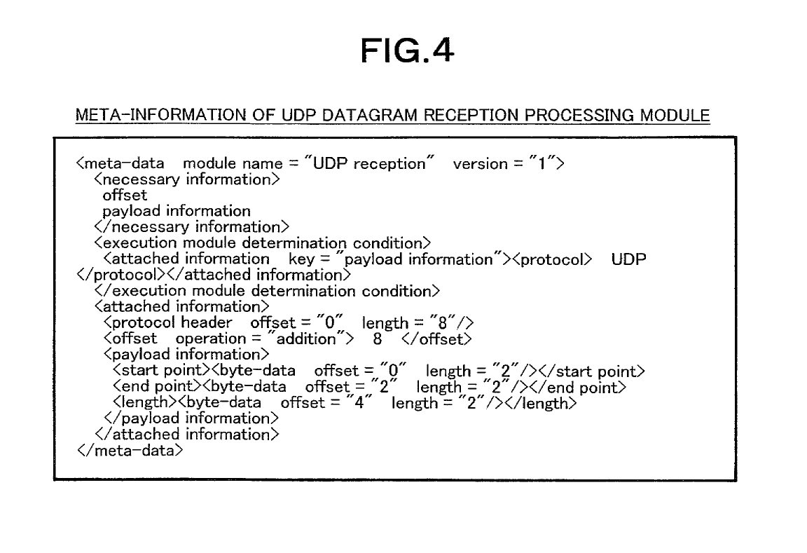

FIGS. 2 to 4 show examples of complete description for defining the meta-information of the modules 140-1, . . . , 140-n in a computer-processable form. Here, an Ethernet frame reception processing module (FIG. 2), an IPv4 packet reception processing module (FIG. 3), and a UDP datagram reception processing module (FIG. 4) are taken as examples of the modules 140-1, . . . , 140-n. Note that the expression and items of the meta-information are not limited to the present examples.

Referring to FIGS. 2 to 4, the meta-information of each module 140-1, . . . , 140-n is expressed as a nested structure of elements described using tags. That is, in the examples of FIGS. 2 to 4, the meta-information of modules 140-1, . . . , 140-n includes elements enclosed between <meta-data> </meta-data> tags, in which elements enclosed between <necessary information> </necessary information> tags, enclosed between <execution module determination> </execution module determination> tags, and enclosed between <attached information> </attached information> tags are described. The above elements correspond to the abovementioned contained items of the meta-information.

The meta-information of the Ethernet frame reception processing module shown in FIG. 2 will be described.

In the example of FIG. 2, the element marked by <meta-data> tag indicates that this description is the meta-information of the Ethernet frame reception processing module (module name=“Ethernet reception”) of version 1 (version=“1”). The character string “offset” placed between <necessary information> </necessary information> tags indicates that, in order for the Ethernet frame reception processing module to process reception data, meta-information indicated by “offset” needs to be attached to the reception data.

Further, <and> </and> and <or > </or > tags placed between the <execution module determination> </execution module determination> tags are used for describing logical AND and logical OR between conditions. In the example of FIG. 2, <or > </or > tags and <attached information> </attached information> tags are placed between the <and> </and> tags and conditions are described between respective tags. That is, OR condition between the condition of whether or not the value of 6 bytes (length=“6”) starting at 6th byte (offset=“6”) from the reception data processing offset position indicated between <byte-data> </byte-data> tags coincides with 0x00004cd738a3 and condition of whether or not the value of 48th bit (offset=“48”) from the reception data processing offset position indicated between the <bit-data> </bit-data> tags is 1 is described between the <or > </or > tags. Further, a description enclosed between the <attached information> </attached information> indicates the condition of whether or not the meta-information indicated by payload information has been attached to the reception data (key=“payload information”) and whether or not the value of the meta-information indicated by the payload information is a character string “Ethernet” placed between <protocol> </protocol> tags. Therefore, in the example of FIG. 2, AND condition between the OR condition (first condition) between the conditions respectively described between the <byte-data> </byte-data> tags and <bit-data> </bit-data> tags placed between the <or > </or > tags and condition (second condition) described between the <attached information> </attached information> tags, that is, whether or not both the first and second conditions are satisfied is the execution module determination condition.

Further, <protocol header offset=“0” length=“14”/> placed between the <attached information> </attached information> tags indicates that the reception data corresponding to 14 bytes starting from the beginning of the data to be processed is attached as the meta-information indicated by “protocol header”.

Further, <offset operation=“addition”>14</offset> indicates that the integer value of 14 is added to the numerical value of the meta-information indicated by “offset” attached to the reception data.

Further, the description enclosed between <payload> </payload> tags indicates that the elements placed between <protocol> </protocol> tags are attached as the meta-information indicated by “payload information”. That is, its content is described between <switch> </switch> tags such that “protocol” can be selected according to a predetermined set condition. In the example of FIG. 2, <byte-data offset=“12” length=“2”/> indicates the value of 2 bytes starting at 12 byte from the beginning of the data to be processed. If the value is 0x0800 (case value=“0x800”), IP is selected, while the value is 0x0806 (case value=“0x0806”), APR (Address Resolution Protocol) is selected.

The meta-information of the IPv4 packet reception processing module shown in FIG. 3 will be described.

In the example of FIG. 3, the element marked by <meta-data>tag indicates that this description is the meta-information of the IPv4 reception processing module (module name=“IPv4 reception”) of version 1 (version=“1”). The character strings “offset” and “payload information” placed between <necessary information> </necessary information> tags indicate that, in order for the IPv4 packet reception processing module to process reception data, meta-information indicated by “offset” and “payload information” need to be attached to the reception data.

Further, <and> </and> tags placed between the <execution module determination> </execution module determination> tags are used for describing logical AND between conditions. In the example of FIG. 3, <bit-data> </bit-data> tags and <attached information> </attached information> tags are placed between the <and> </and> tags and conditions are described between respective tags. That is, a condition of whether or not the value of 4 bits (length=“4”) starting at 0th bit (offset=“0”) from the reception data processing offset position coincides with 0010 is described between <bit-data> </bit-data> tags. Further, a description enclosed between the <attached information> </attached information> indicates the condition of whether or not the meta-information indicated by payload information has been attached to the reception data (key=“payload information”) and whether or not the value of the meta-information indicated by the payload information is a character string “IP” placed between <protocol> </protocol> tags. Therefore, in the example of FIG. 3, AND condition between the condition (first condition) described between the <bit-data> </bit-data> tags and condition (second condition) described between the <attached information> </attached information> tags, that is, whether or not both the first and second conditions are satisfied is the execution module determination condition.

Further, <protocol header offset=“0” length=“20”/> placed between the <attached information> </attached information> tags indicates that the reception data corresponding to 20 bytes starting from the beginning of the data to be processed is attached as the meta-information indicated by “protocol header”.

Further, <offset operation=“addition”> <bit-data offset=“4” length=“4” shift=“4”> </offset> indicates that the value of 4 bits starting at 4th bit from the reception data processing offset position is added to the numerical value of the meta-information indicated by “offset” attached to the reception data.

Further, the elements enclosed between <payload information> </payload information> tags indicates that the elements placed between <protocol> </protocol> tags are attached as the meta-information indicated by “payload information”. That is, its content is described between <switch> </switch> tags such that “protocol2 can be selected according to a predetermined set condition. In the example of FIG. 3, <byte-data offset=“9” length=“1”/> indicates the value of 1 byte starting at 9th byte from the beginning of the data to be processed. If the value is 0x01 (case value=“0x01”), ICMP (Internet Control Message Protocol) is selected; if the value is 0x04 (case value=“0x04”), IP-in-IP is selected; if the value is 0x06 (case value=“0x06”), TCP is selected; if the value is 0x11 (case value=“0x11”), UDP is selected and if the value is 0x46 (case value=“0x46”), IPv6-over-IP is selected.

The meta-information of the UDP datagram reception processing module shown in FIG. 4 will be described.

In the example of FIG. 4, the element marked by <meta-data> tag indicates that this description is the meta-information of the UDP datagram reception processing module (module name=“UDP reception”) of version 1 (version=“1”). The character strings “offset” and “payload information” placed between <necessary information> </necessary information> tags indicate that, in order for the Ethernet reception processing module to process reception data, meta-information indicated by “offset” and “payload information” need to be attached to the reception data.

Further, <attached information> </attached information> tags are placed between the <execution module determination> </execution module determination> tags and conditions are described therebetween. That is, between the <attached information> </attached information> tags, an execution module determination condition of whether or not the meta-information indicated by payload information has been attached to the reception data (key=“payload information”) and whether or not the value of the meta-information indicated by the payload information is a character string “UDP” placed between <protocol> </protocol> tags is described.

Further, <protocol header offset=“0” length=“8”/> placed between the <attached information> </attached information> tags indicates that the reception data corresponding to 8 bytes starting from the beginning of the data to be processed is attached as the meta-information indicated by “protocol header”.

Further, <offset operation=“addition”> 8</offset> indicates that the integer value of 8 is added to the numerical value of the meta-information indicated by “offset” attached to the reception data.

Further, the elements enclosed between <payload information> </payload information> tags indicates that the elements indicated by <start point> </start point> tags, <end point> </end point> tags, and <length> </length> tags are attached as the meta-information indicated by “payload information”. That is, the element enclosed between the <start point> </start point> tags is reception data corresponding to 2 bytes (length=“2”) starting from the beginning (offset=“0”) of the data to be processed. The element enclosed between the <end point> </end point> tags is reception data corresponding to 2 bytes (length=“2”) starting from the beginning (offset=“0”) of the data to be processed. The element enclosed between the <length> </length> tags is reception data corresponding to 2 bytes (length=“2”) starting from 4th byte (offset=“0”) of the data to be processed.

In the case where any of the modules indicated by the meta-information is determined as a module for executing processing for the reception data, the attached information of the determined module is added or (updated) to the received data.

The abovementioned meta-information need not be sufficiently detailed to allow complete determination of the connection order of the modules 140-1, . . . , 140-n. When the execution order of the modules 140-1, . . . , 140-n cannot be determined from the meta-information, the next modules 140-1, . . . , 140-n (to process the reception data) is determined after the reception data has actually been processed by the protocol processing section of the preceding modules 140-1, . . . , 140-n.

In the above examples, the offset value required for processing determination or a value of a specific filed in the header are directly described in the meta-information. However, in actual implementation, syntactic sugar may be used so as to allow the name or the like of a header filed defined by the specification of the protocol to be utilized for meta-information definition.

In the case of the metal-information of the Ethernet frame reception processing module, for example, the description of <byte-data offset=“6” length=“6”>0x00004cd738a3</byte-data> may be represented as <EtherDest>0x00004cd738a3</EtherDest>.

The entire operation in the present example will be described in detail.

First, a packet is received by any of the packet receiving sections 110-1, . . . , 110-x of the communication apparatus 100. The packet receiving section 110-1, . . . , 110-x that has received the packet attaches, to the incoming packet, an identifier thereof and information for identifying a transmission device connected thereto as the meta-information. The packet, i.e., reception data is then passed to the module retrieval information imparting section 120 from the packet receiving section 110-1, . . . , 110-x.

The module retrieval information imparting section 120 passes the reception data to the transmission path restriction calculating section 130.

Then, based on the reception data and meta-information of the respective modules 140-1, . . . , 140-n retained in the meta-information retaining section 142, the transmission path restriction calculating section 130 calculates the deployment order of modules 140-1, . . . , 140-n so that the packet is adequately processed. This calculation is performed according to the following procedure.

That is, the transmission path restriction calculating section 130 sequentially applies the reception data and meta-information attached to the reception data by the packet receiving sections 110-1, . . . , 110-x to the condition of the meta-information of the respective modules so as to sequentially pick out the matching modules 140-1, . . . , 140-n.

It is possible to include, in the execution module determination condition included in the meta-information of the respective modules 140-1, . . . , 140-n, the presence/absence of the information that other modules 140-1, . . . , 140-n attach to the reception data, so that a dependency can be established between the modules 140-1, . . . , 140-n. The dependency between the modules 140-1, . . . , 140-n can dynamically be changed by changing the meta-information to the reception data depending on the content of the reception data.

Thus, in the case where a module having a new function needs to be inserted between the modules for the data processing, it is only necessary to add to the apparatus a new module adequately describing the meta-information, while it has conventionally been necessary to reconstruct a connection graph of the modules even if modularized communication software is employed. Therefore, it is possible to perform replacement of the module and easily change the function of the module in an easier manner than in the case where communication software constituted by protocol modules statically connected to one another.

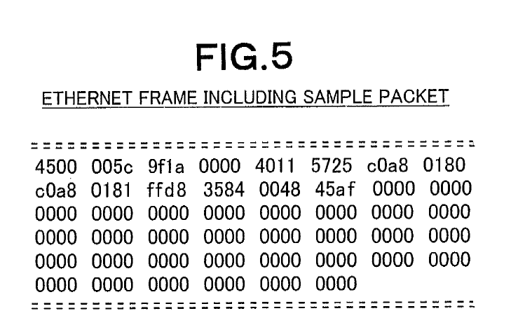

Next, a concrete example of the processing in which the module connection order is determined using the communication apparatus 100 implementing the Ethernet, IP, and UDP will be described with reference to FIGS. 5 to 11.

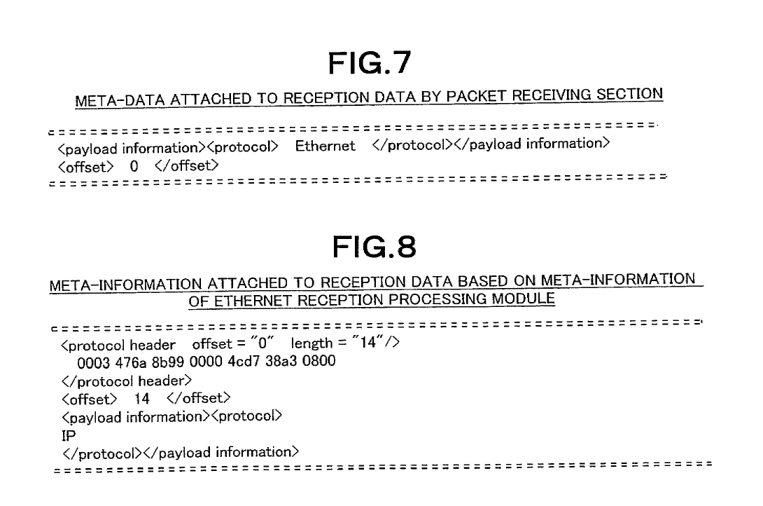

In the example shown in FIGS. 5 to 11, it is assumed that the packet receiving sections 110-1, . . . , 110-x are connected to the Ethernet. In this case, the packet receiving sections 110-1, . . . , 110-x previously know that reception data is an Ethernet frame, so that they attach to the reception data payload information indicating that the reception data is the data on the Ethernet protocol as the meta-information as shown in FIG. 7. The packet receiving sections 110-1, . . . , 110-x attach processing offset 0 to the reception data as well.

Based on the above attached information and meta-information of the Ethernet reception processing module, it is possible to determine that the Ethernet reception processing module is a module to be executed for the reception data. It is possible to know, at the same time, that any other modules 140-1, . . . , 140-n are not selected as a module to be executed for the reception data. As a result, the Ethernet reception processing module can be determined as a module to process the reception data first.

The Ethernet reception processing module then updates the attached information of the reception data with information shown in FIG. 8. By conducting the execution module determination based on the reception data and meta-data, it is possible to know that the IPv4 reception processing module is the next module 140-1, . . . , 14-n to be executed for the reception data.

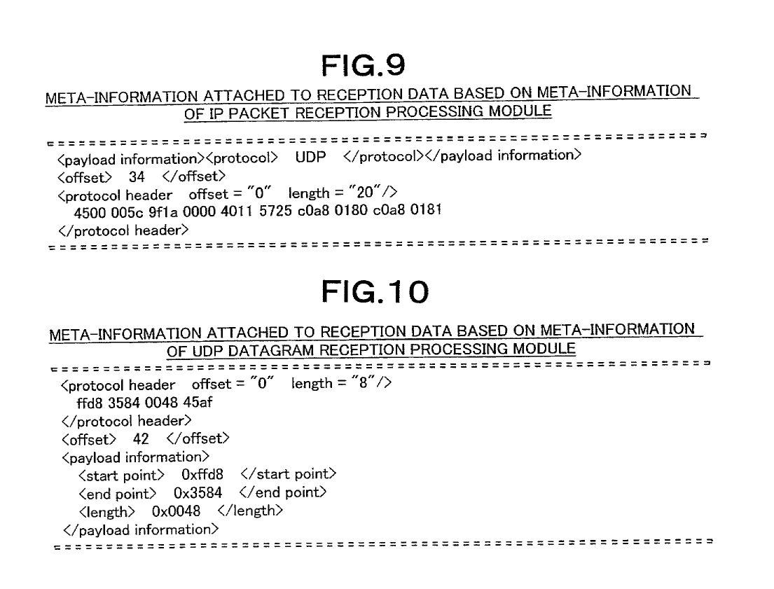

The IPv4 reception processing module then updates the attached information of the reception data with information shown in FIG. 9. By conducting the execution module determination based on the reception data and meta-data, it is possible to know that the UDP reception processing module is the next module to be executed for the reception data.

The UDP reception processing module then updates the attached information of the reception data with information shown in FIG. 10. By conducting the execution module determination based on the reception data and meta-data, it is possible to know that there is no module 140-1, . . . , 14-n to be executed next.

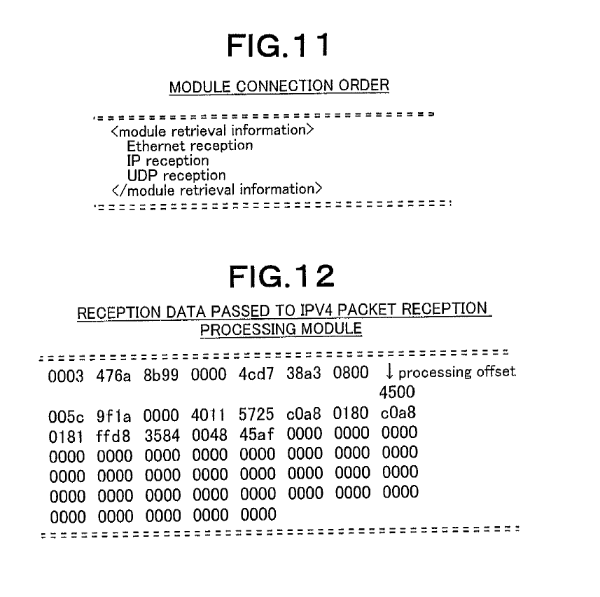

According to the above procedure, the transmission path restriction calculating section 130 determines, with respect to the passed reception data, the deployment order of the modules 140-1, . . . , 140-n (module connection order) that process the reception data. In the case of the present example, the deployment order is as follows (from first to last): Ethernet reception processing module>IPv4 reception processing module>UDP reception processing module, as shown in FIG. 11. The transmission path restriction calculating section 130 transmits the deployment order to the module retrieval information imparting section 120.

The flow of the processing from reception of an Ethernet frame to determination of the module connection order will be described below.

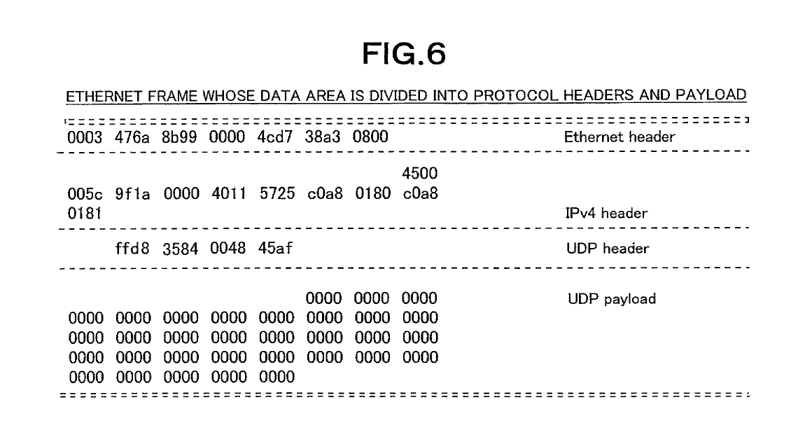

(1) The packet receiving section 110-1, . . . , 110-x receives an Ethernet frame including a packet shown in FIG. 5. The Ethernet frame is constituted by a protocol header and a payload, as shown in FIG. 6. After receiving the Ethernet frame, the packet receiving section 110-1, . . . , 110-x attaches the meta-data element shown in FIG. 7 to the reception data. In the example of FIG. 7, “Ethernet” described in “protocol” indicated in “payload information” is included as the meta-data element.

(2) The packet receiving section 110-1, . . . , 110-x passes to the transmission path restriction calculating section 130 the reception data to which the meta-data element has been attached.

(3) Then, the transmission path restriction calculating section 130 checks whether or not the reception data and meta-data element attached to the reception data match the “execution module determination condition” of the meta-information stored in the meta-information retaining section 442 of the respective modules 140-1, . . . , 140-n and identifies the matched module 140-1, . . . , 140-n based on a result of the matching check. In the present example, only the Ethernet reception processing module is matched.

This is because that “Ethernet” is described in “protocol” indicated in “payload information” of the meta-data shown in FIG. 7 and that the module 140-1, . . . , 140-n with respect to which the meta-data element and “execution module determination condition” in the meta-information match each other is only the Ethernet reception processing module.

(4) The identified Ethernet reception processing module attaches to the reception data meta-information elements shown in FIG. 8 according to the “attached information” (see FIG. 2) of the meta-information stored in the meta-information retaining section 442 thereof to thereby update the attached information of the reception data. In the example of FIG. 8, elements indicated by the “protocol header”, “offset”, and “payload information” are attached to the reception data as the meta-information element. The element of the “protocol header” is the value (0x0003476a8b990004cd738a30800) corresponding to 14 bytes from the beginning of the data to be processed. The element of the “offset” is 14. The element of the “protocol” in the “payload information” is IP.

(5) The transmission path restriction calculating section 130 then checks whether or not the reception data and meta-information elements attached (or updated) to the reception data match the “execution module determination condition” of the meta-information stored in the meta-information retaining section 442 of the respective modules 140-1, . . . , 140-n and identifies the matched module 140-1, . . . , 140-n based on a result of the matching check. In the present example, only the IP reception processing module is matched. This is because that “IP” is described in “protocol” indicated in “payload information” shown in FIG. 8, that the module 140-1, . . . , 140-n with respect to which the meta-information element and “execution module determination condition” in the meta-information match each other is only the IPv4 reception processing module, and that the first 4 bits of the reception data is 0010 (IPv4).

(6) The identified IPv4 reception processing module attaches to the reception data meta-information elements shown in FIG. 9 according to the “attached information” (see FIG. 3) of the meta-information stored in the meta-information retaining section 442 thereof. In the example of FIG. 9, elements indicated by the “protocol header”, “offset”, and “payload information” are attached to the reception data as the meta-information. The element of the “protocol header” is the value (0x4500005c9f1a000040115725c0a80180c0a80181) corresponding to 20 bytes from the beginning of the data to be processed. The element of the “offset” is 34. The element of the “protocol” in the “payload information” is UDP.

(7) The transmission path restriction calculating section 130 then checks whether or not the reception data and meta-information elements attached (or updated) to the reception data match the “execution module determination condition” of the meta-information stored in the meta-information retaining section 442 of the respective modules 140-1, . . . , 140-n and identifies the matched module 140-1, . . . , 140-n based on a result of the matching check. In the present example, only the UDP reception processing module is matched. This is because that “UDP” is described in “protocol” indicated in “payload information” shown in FIG. 9, and that the module 140-1, . . . , 140-n with respect to which the meta-information element and “execution module determination condition” in the meta-information match each other is only the UDP reception processing module.

(8) The identified UDP reception processing module attaches to the reception data meta-information elements shown in FIG. 10 according to the “attached information” (see FIG. 4) of the meta-information stored in the meta-information retaining section 442 thereof. In the example of FIG. 10, elements indicated by the “protocol header”, “offset”, and “payload information” are attached to the reception data as the meta-information. The element of the “protocol header” is the value (0xffd83584004845af) corresponding to 8 bytes from the beginning of the data to be processed. The element of the “offset” is 42. The element of the “start point” in the “payload information” is 0xffd8. The element of the “end point” in the “payload information” is 0x3584. The element of the “length” in the “payload information” is 0x0048.

(9) The transmission path restriction calculating section 130 then checks whether or not the reception data and meta-information elements attached (or updated) to the reception data match the “execution module determination condition” of the meta-information stored in the meta-information retaining section 442 of the respective modules 140-1, . . . , 140-n and identifies the matched module 140-1, . . . , 140-n based on a result of the matching check. In the present example, there does not exist any more matched module 140-1, . . . , 140-n.

(10) With the above procedure, the transmission path restriction calculating section 130 creates the module connection order shown in FIG. 11. In the example of FIG. 11, the module connection order is enclosed between <module retrieval information> </module retrieval information> tags. The order is as follows (from first to last): Ethernet reception processing module>IPv4 reception processing module>UDP reception processing module.

The module retrieval information imparting section 120 attaches to the reception data information of the transmitted module connection order (deployment order of the modules 140-1, . . . , 140-n) as the meta-information. Then, the module retrieval information imparting section 120 picks up information of the first module 140-1, . . . , 140-n (in the present example, Ethernet reception processing module) in the deployment order and passes the reception data to the corresponding module 140-1, . . . , 140-n.

The module 140-1, . . . , 140-n that has received the reception data uses the protocol processing section provided therein to process the reception data according to a protocol processing procedure implemented therein. This protocol processing includes, e.g., a change of a node state in each protocol, rewrite of the header or payload, attachment of the meta-information concerning the protocol processing to a packet, and the like.

For example, the protocol processing in the IPv4 reception processing module is performed as follows. The following description is based on Non-patent document (“TCP/IP Illustrated, Volume 2: The implementation” written by G. R. Wright and one other, translated by Hideyuki Tokuda and one other, published by Pearson Education Japan in December 2002, Chapter 8).

Here, assumed is a case where the packet reception section 110-1, . . . , 110-x has received the Ethernet frame, processing by the Ethernet reception processing module of modules 140-1, . . . , 14-n has normally been completed, and reception data shown in FIG. 12 has been passed to the IPv4 reception processing module.

(1) In this case, the IP reception processing module reads data starting from the processing offset which is described in the meta-information attached to the reception data passed from the Ethernet reception processing module. In the example of FIG. 12, data starting from 0x4500 which is 14th byte (see value of “offset” of FIG. 8) from the beginning of the reception data is read as the processing offset.

(2) The IP reception processing module confirms that the first 4 bits (version number) of the read reception data is “0100”.

(3) The IP reception processing module multiplies 5-8th bit data (in this case, “0011”) by four to obtain the header length and confirms that the header length falls within the range defined in the specification and is shorter than the length of the residual data.

(4) The IP reception processing module checks the header checksum stored in 10-11th byte of the read reception data.

(5) The IP reception processing module confirms that the entire packet length stored in 3-4th byte of the read reception data is shorter than the length of the reception data.

(6) The IP reception processing module processes an IP option, if exists.

(7) The IP reception processing module matches the interface address to destination address of the packet to check whether or not the packet can be received by its own node (in this example, it is determined that the packet can be received).

(8) The IP reception processing module performs reassemble processing if the packet has been fragmented.

After completion of the above protocol processing performed in a module 140-1, . . . , 140-n, the next module retrieving section 142 provided in the corresponding module 140-1, . . . , 140-n determines, based on the meta-information of the reception data, a next module 140-1, . . . , 140-n to be executed for the reception data. The procedure of the processing is as follows.

(1) In the case where a next module 140-1, . . . , 140-n to be executed is specified in the meta-information in the packet, the next module retrieving section 142 passes the packet to the specified next module 140-1, . . . , 140-n.

(2) In the case where a next module to be executed determined in the protocol processing performed by its own module differs from one specified in the meta-information, the next module retrieving section 142 passes the packet to the next module 140-1, . . . , 140-n determined in the protocol processing.

(3) In the case where there is no module 140-1, . . . , 140-n to be executed next, the next module retrieving section 142 ends the packet processing and waits for the next packet processing.

(4) In the case where there is a need to transmit the processed data, the next module retrieving section 142 passes the processed data to the packet transmitting section 150-1, . . . , 150-y.

(5) If unable to determine the next processing, the next module retrieving section 142 discards the packet. In this case, the next module retrieving section 142 performs predetermined processing.

The protocol processing of the modules 140-1, . . . , 140-n continues until completion of the processing for the reception data or until any one of the modules 140-1, . . . , 140-n passes the data to the packet transmitting section 150-1, . . . , 150-y. When the processed data is passed to the packet transmitting section 150-1, . . . , 150-y, the packet transmitting section 150-1, . . . , 150-y transmits the data as a packet to a data link connected thereto, whereby the protocol processing is ended.

In the above matching check of the meta-information, a portion of the received data for which execution module 140-1, . . . , 140-n cannot be determined can occur. For example, in reception data including an ESP (Encapsulated Security Payload) (see “IP Encapsulating Security Payload (ESP)”, written by S. Kent and one other, RFC2, November, 1998), the payload portion following the ESP header is encrypted, so that the processing content of the portion following the ESP header cannot be determined unless the encrypted portion is decrypted. In such a case, the following configuration may be adopted: the processing order up to the ESP reception module is previously determined; and after the reception data is processed using the ESP module, the next module is determined based on the protocol information included in the decrypted payload.

In the above case, or in a case where the description of the meta-information is not so sufficiently detailed as to allow determination of the processing order of the reception data, the connection order of the modules is previously determined to the extent possible. In this case, when the reception data reaches the last module in the previously determined connection order of the modules, the next module is determined based on a result obtained after the reception data has actually been processed by the protocol processing section in the last module.

Alternatively, in the case where the next module can be estimated through the protocol processing, information of default next execution module can be included in the meta-information of the module. In this case, if the next execution module cannot be determined from the reception data, the default next execution module is applied. If it is determined, after the reception data has actually been processed, that the reception data needs to be processed by a module different from the default module, the former module is prioritized.

### Example 2

A second example of the present invention will next be described. The present example adopts a configuration including a non-modular application in addition to the configuration of the first example.

It is assumed in the communication apparatus according to the first example that all software used for reception/transmission data processing exist as modules according to the method of the present invention. To satisfy this assumption, it is necessary to convert existing communication applications into a modular configuration according to the present method. This may induce unfavorable effect. Namely, execution of the conversion work may increase the cost, or there may be a risk that new bags may be introduced with the conversion work. To solve this, an interface is provided between communication software according to the present method and software not conforming to the present method so as to hide the configuration according to the present method from other software. The present example is configured with this point taken into consideration.

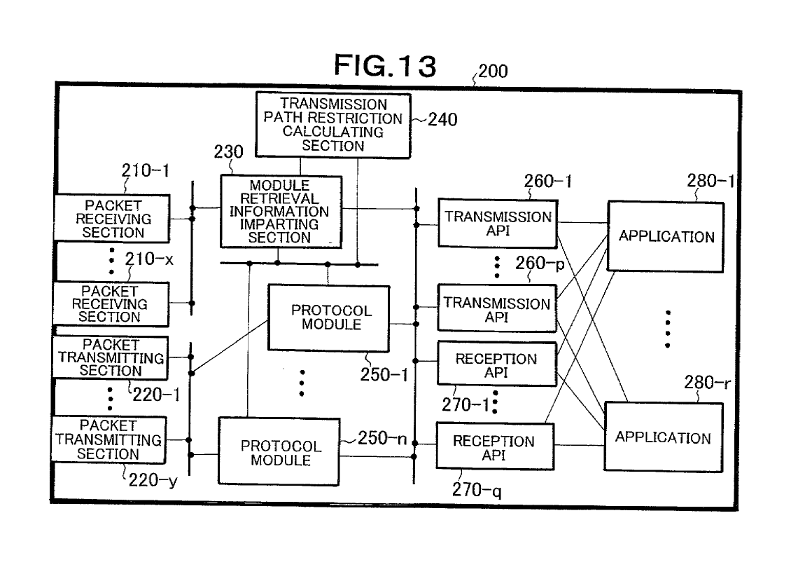

FIG. 13 is a block diagram showing a configuration of the present example. Referring to FIG. 13, a communication apparatus 200 according to the present example includes one or more transmission APIs 260-1, . . . , 260-p and reception APIs 270-1, . . . , 270-q, and application software (hereinafter, abbreviated as “application”) 280-1, . . . , 280-r, in addition to the components of the first example.

The applications 280-1, . . . , 280-r are connected respectively to the corresponding transmission APIs 260-1, . . . , 260-p and reception APIs 270-1, . . . , 270-q. The transmission APIs 260-1, . . . , 260-p are connected to a module retrieval information imparting section 230. The reception APIs 270-1, . . . , 270-q are connected respectively to modules 250-1, . . . , 250-n.

As the applications 280-1, . . . , 280-r, those such as a HTTP (Hyper Text Transfer Protocol) and SIP (Session Initiation Protocol) that utilize a socket API may be used. However, the type of the applications 280-1, . . . , 280-r is not limited to the above example, and any type of software may be used as long as it communicates with other nodes or other applications via the modules 250-1, . . . , 250-n.

The operation in the present example will be described.

A packet received from an external device is processed in the same manner as the first example. However, in the present example, a case where the packet that has been subjected to processing by the modules 250-1, . . . , 250-n is passed not to the packet transmitting sections 220-1, . . . , 220-y but to the reception APIs 270-1, . . . , 270-q is added. The reception data passed to the reception APIs 270-1, . . . , 270-q is further passed to the applications 280-1, . . . , 280-r and subjected to processing.

The data that the applications 280-1, . . . , 280-r transmit is passed to the transmission APIs 260-1, . . . , 260-p. The transmission APIs 260-1, . . . , 260-p attach information specified by the applications 280-1, . . . , 280-r that have transmitted the data thereto to the transmission data as meta-data and pass the resultant transmission data to the module retrieval information imparting section 230.

The module retrieval information imparting section 230 deploys the modules 250-1, . . . , 250-n to be executed for the corresponding data based on the supplied transmission data and meta-data, attaches the deployment information to the transmission data as meta-information, and returns the resultant transmission data to the module retrieval information imparting section 230. The transmission data is then processed by the modules 250-1, . . . , 250-n, starting from the set first module.

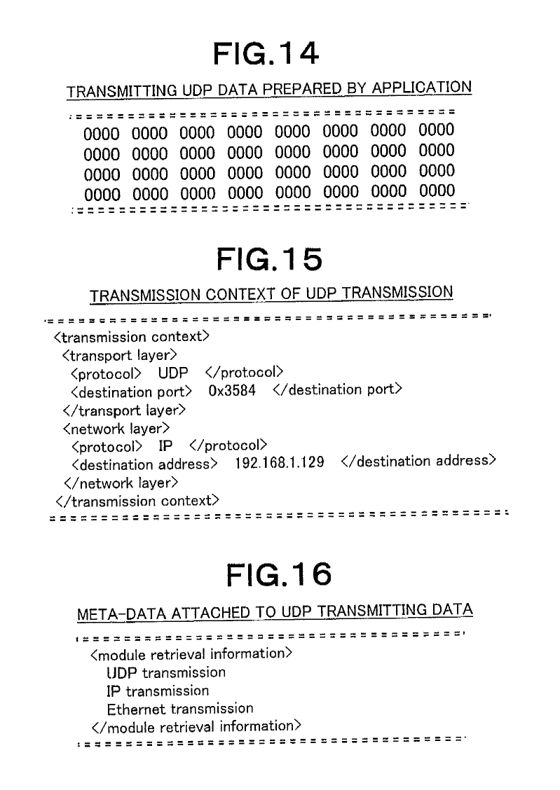

A concrete transmission processing for the UDP datagram according to the present example will be described with reference to FIGS. 14 to 16. In this example, data is transmitted on the UDP from the applications 280-1, . . . , 280-r.

(1) The applications 280-1, . . . , 280-r prepare transmitting UDP data shown in FIG. 14.

(2) The applications 280-1, . . . , 280-r prepare a destination address and a destination port as a transmission context of the transmitting UDP data shown in FIG. 15.

(3) The applications 280-1, . . . , 280-r pass the prepared data to the transmission APIs 260-1, . . . , 260-p.

(4) The transmission APIs 260-1, . . . , 260-p pass the data from the applications 280-1, . . . , 280-r to the module retrieval information imparting section 230.

(5) The module retrieval information imparting section 230 creates meta-data shown in FIG. 16 from the transmission context of the transmitting UDP data shown in FIG. 15 and attaches the meta-data to the packet.

(6) The packet is then processed in the same procedure as in the packet reception time.

As described above, in the present example, the applications 280-1, . . . , 280-r attach the information concerning the use protocol and end point to the transmitting UDP data to the transmission APIs 260-1, . . . , 260-p, and the transmission APIs 260-1, . . . , 260-p use the corresponding meta-information to determine the module 250-1, . . . , 250-n to be used.

Although the meta-data is used to specify that the application uses the UDP in the present example, the present invention is not limited to this, but a configuration can be considered in which a more abstract meta-data is used.

For example, in the case where a method of an object placed on a remote node by a SOAP (see Simple Object Access Protocol (SOAP) 1.1, W3C Note 8 May 2000, http://www.w3.org/TR/NOTE-SOAP-2000508), a communication protocol for transmitting a SOAP message to the remote node is not particularly limited. Therefore, an application that performs RPC via the soap message only needs to specify the URL of a call destination application and may put selection of a transmission path in the hands of the protocol modules. In such a case, the protocol modules select an adequate transmission protocol based on information such as name resolution and reachability.

### Example 3

A third example of the present invention will next be described. The present example is directed to a configuration in which only the meta-information are retained in the apparatus.

It is assumed in the first example that all the modules previously exist in the communication apparatus. However, it is difficult for a communication apparatus having a small memory capacity to retain all the modules potentially used in the apparatus. For example, a small-sized router for small office, a set-top box providing a communication function to home electric appliances such as TV broadcast receiver, and a mobile phone terminal correspond to this.

In such a apparatus, it is effective to provide a means for acquiring required modules via a network and deleting modules or resources no longer required in order to make the best use of resources. That is, only the meta-information of the modules potentially used for communication are retained in the apparatus and, at the time point when it becomes clear, by the transmission path restriction calculation, that a module whose meta-information has been retained is required for processing of an incoming packet, the required module is acquired via a network. With this configuration, it is possible to acquire a required module in a dynamic manner.

The present example adopts a configuration including a means for acquiring the modules via a network in addition to the configuration of the first example.

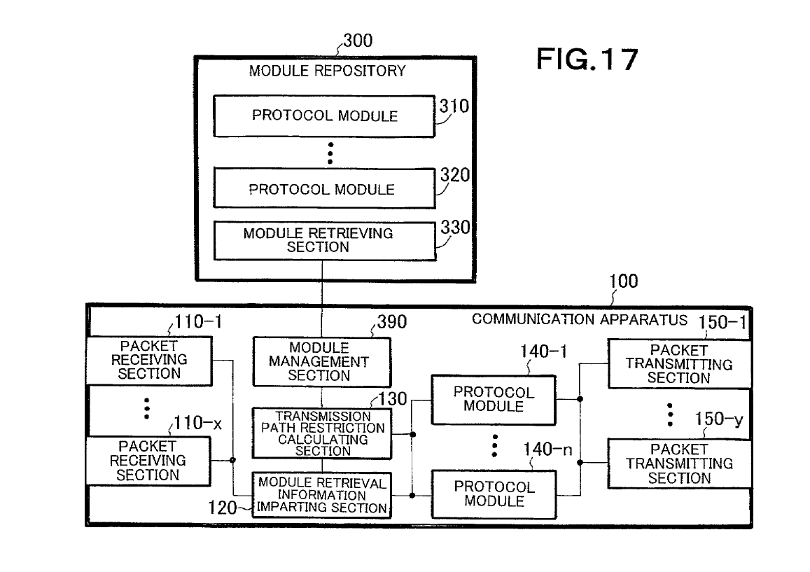

FIG. 17 shows a configuration of the present example. In FIG. 17, a module repository 300 is provided on a network to which a communication apparatus 100 according to the present example is connected. The module repository 300 retains all modules 310 that the communication apparatus 100 of the present example uses and is configured to transmit modules 310, 320 to the communication apparatus 100 in response to a request from the communication apparatus 100.

The module repository 300 can be constituted not only by a single server, but also a plurality of servers in which the modules are retained in a distributed manner. Further, it is possible to adopt a configuration in which one communication apparatus is configured to able to copy the modules 310, 320 retained therein in response to a request from another communication apparatus so as to allow the entire communication apparatus to serve as the module repository 300. In the case where the module repository 300 is realized by a plurality of apparatuses, it is necessary to additionally prepare a retrieving system capable of searching for the location of the modules 310, . . . , 320 for acquisition. This retrieving system performs processing of identifying the respective modules by using the meta-information of the modules 310, 320 as a key. In order to increase the retrieving speed, a short identifier, such as 32-bit integer, for uniquely identifying the meta-information may be included in the meta-information.

A module management section 390 is prepared in each communication apparatus 100. The module management section 390 retains a list of the modules 140-1, . . . , 140-n retained in the apparatus 100 and a means for communicating with the module repository 300.

The module management section 390 checks use module information determined by the transmission path restriction calculating section 130. When determining, in the check, that there is any module that is not registered in the list of the modules, the module management section 390 acquires the corresponding module 310, . . . , 320 from the module repository 300. With this configuration, it is possible to realize a function of acquiring a required module in a dynamic manner.

In the case where there are modules having less chance of being used for the present in the apparatus 100 when resources run short, a module deletion means is provided so as to allow the relevant modules or resources that the relevant modules use to be temporarily deleted from the apparatus 100. Such a module delete means can be realized as follows.

A module use monitoring section is prepared in the communication apparatus 100. The module use monitoring section collects the usage information on the modules existing in the apparatus and organizes information for use in determination of unnecessary modules. The module usage information includes, e.g., the number of times of processing of reception data, memory usage amount, and amount of CPU usage time within a past predetermined time.

Further, a resource monitoring section for monitoring the usage degree of resources provided in the communication apparatus 100 is prepared. In addition, a module management section for determining the priority of modules based on the module usage information and resource usage degree is prepared (this module management section and the abovementioned management section for adding the modules may be implemented integrally, but their functions differ from each other). The module management section refers to the usage amount of the system resources and usage frequency of the modules to determine a module to be deleted according to a predetermined rule. When determining that there is any module to be deleted, the module management section deletes the relevant module or data that the module has from the apparatus.

According to the configuration of the present example, it is possible to continue the processing while changing a required module, thereby providing an apparatus capable of realizing many functions with less resource.

### Example 4

A fourth example of the present invention will next be described. The present example is directed to a configuration in which the module connection order is cached.

In the configuration of the first example, the module connection order is calculated for each reception of a packet. Thus, it is likely that packet processing efficiency significantly decreases. To avoid this, the configuration of the first example is modified as follows. That is, after the module connection order is once calculated with respect to a packet starting a given flow, the calculated module connection order is cached, and this cached module connection order is applied to the subsequent packets belonging to this follow.

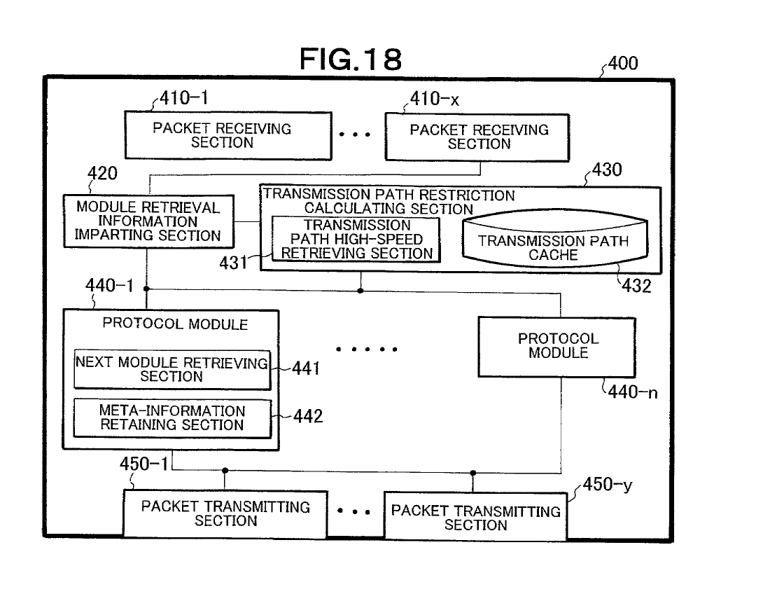

FIG. 18 is a block diagram showing a configuration of the present example. A packet processing apparatus 400 shown in FIG. 18 includes, in a transmission path restriction calculating section 430, a transmission path cache 432 and a transmission path high-speed retrieving section 431.

The transmission path restriction calculating section 430 calculates module connection order based on the meta-information with respect to an incoming packet and, when a predetermined condition is satisfied, retains the calculated module connection order in the transmission path cache 432. When receiving a packet and calculating the module connection order with respect to the packet in the next (and subsequent) time, the transmission path restriction calculating section 430 searches for a cache storing the calculated module connection order using a predetermined portion of the header of the packet as a key and returns the module connection order recorded in the entry of the hit cache to the module retrieval information imparting section 420.

As a condition for storing the module connection order in the cache, module retrieval information such as “Ethernet reception”, “IPv4 reception”, or “TCP reception” is generated when a packet (including a SYN flag) is subjected to transmission/reception processing starting, e.g., TCP connection. In this case, information for identifying TCP end-points, i.e., IP addresses and port numbers of the local and remote sides, is retained as the cache retrieval condition.

The portions of the header information of a packet used when the search is performed with respect to a cache that stores the module connection order are, e.g., source and destination addresses of an IP header and those of a TCP header. The retrieval condition is checked by using the source address as the local side address in the case of a transmission packet and using the source address as the remote side address in the case of a reception packet. When there is a matching entry, the module retrieval information stored in the corresponding cache is used.

Thus, according to the present example, when it can be estimated that packets to which the same module execution order can be applied sequentially reach, the information of the module execution order which has been used for processing the first packet of the series of packets is stored and retained in the cache and, when the next and subsequent packets are received, the relevant cache is searched for. This allows determination of the module execution order without the need for determining whether or not each module can execute processing of the reception data.

### Example 5

A fifth example of the present invention will next be described. The present example is directed to a configuration in which a module is replaced with another one in a non-stop/non-configuration mode.

There is a case where a protocol module is updated for error correction or addition of a new function. In such a case, the update of the module needs to be performed in a non-stop/non-configuration mode. Otherwise, a service may stop every time the module is updated or a user or person in charge of maintenance may have to take time for a setting work.

In order to cope with the problem, the present example adopts a configuration in which the update of the module can be performed in a non-stop/non-configuration mode. In this case, the meta-information before update and that after update may be the same one, or, in the case where a new function is added, identification information indicating the addition of a new function may be included in the meta-information.

Further, in the present example, the cache information described in the fourth example is prepared for each packet flow. The identifiers of modules to be used are previously retained in the cache. With respect to packets that match the cache, modules at the time point when the packet flow is started are used continuously. When a new packet flow is started, the transmission path restriction calculation is newly performed, so that in the case where there exist modules having the same function but different (old and new) versions, the new module is used.

As described above, in the present example, it is possible to complete the update of the module without interruption of the packet processing only by adding a new module to the apparatus.

Further, by combining the third example with the present example, it is possible to omit the work of explicitly adding an updated module to respective communication apparatuses. That is, when the updated module is registered in the module repository, the module that can be searched for by using the meta-information becomes the updated one. Further, a function of detecting, at a predetermined time point, the update of the module existing in the apparatus is added to the module management sections of the respective communication apparatuses. A concrete example of the above predetermined time point is, e.g., a time when the amount of communication is small (e.g., early morning), or time when the amount of communication falls below a predetermined threshold value.

When detecting that a module that can be searched for in the module repository is updated (for example, a module in the module repository is newer than the corresponding module existing in the apparatus), the module management section acquires the updated (new) module.

According to the present example, it is possible to complete the update of the module without making any setting at all only by adding a new module to the module repository.

### INDUSTRIAL APPLICABILITY

The present invention is applicable to a packet relay apparatus constituting an IP network, a protocol terminating apparatus. In particular, the present invention is effectively applied to an apparatus having a complicated functional structure and expected to undergo functional update. Concrete examples include a firewall, an intrusion detector, a content filter which provide a security function, a house-hold set-top box providing a network function to home electric appliances.

1-15. (canceled)

16. A communication apparatus including a set of a plurality of modules that perform protocol processing, comprising:
meta-information retaining means for retaining predetermined meta-information for each module implementing a protocol; and
calculating means for calculating connection order of the modules based on the meta-information and a packet to be processed.

17. The communication apparatus according to claim 16, wherein
the meta-information includes: a rule according to which it is determined whether each module can execute processing of a packet to be processed; module information on a result of the determination of whether or not each module can execute the processing of a packet to be processed, which is necessary for such determination; and information attached to the packet to be processed so as to be used for the determination of whether other modules can process the packet, and
the calculating means determines, according to the rule whether each module can perform processing of a packet to be processed and, when it is determined that one module can process the packet, attaches to the packet the information used for the determination of whether other modules can process the packet, and uses the information retained by respective modules, data of the packet, and information attached to the packet to output connection order of modules which have been determined to complete processing of the entire portion of the packet.

18. A communication apparatus including a set of a plurality of modules that perform protocol processing, comprising:
means for individually retaining predetermined meta-information of respective modules;
means for determining the packet processing order between the plurality of modules based on a packet to be processed and meta-information individually retained in the plurality of modules;
means for attaching the information concerning the determined packet processing order to the packet; and
means for allowing each module to determine a transmission destination of the packet based on the information concerning the packet execution order which has been attached to the packet.

19. The communication apparatus according to claim 18, further comprising:
means for determining whether each module can process at least the header information of the packet based on the packet and meta-information individually retained in the respective modules;
means for identifying the modules that can process at least the header information of the packet and attaching to the packet information in which the identification information of the identified modules are sequentially connected as information indicating packet processing order; and
means for passing the packet to the next identified module according to the order that the information attached to the packet indicates so as to allow the module to perform processing of the packet.

20. The communication apparatus according to claim 19, further comprising:
application software that performs communication via the plurality of modules;
a transmission application program interface (API) and reception application program interface (API) connected between the plurality of modules and application software; and
means for calling means for determining the packet processing order between the transmission API and plurality of modules.

21. The communication apparatus according to claim 19, further comprising:
means for performing communication with a module repository in which the plurality of modules are stored;
means for retaining only the meta-information of the plurality of modules in a separated manner from the plurality of modules;
means for acquiring, when it has been determined that one module of the plurality of modules is needed for packet processing, the one module from the module repository; and
means for deleting a no longer required module from the communication apparatus.

22. The communication apparatus according to claim 19, further comprising:
means for storing and retaining information of the packet processing order between the plurality of modules in a cache; and
means for searching information of the cache so as to determine the packet processing order between the plurality of modules.

23. The communication apparatus according to claim 21, further comprising:
means for detecting, in the case where the module stored in the module repository is updated, the update of the module; and
means for acquiring a module after update at the time of update of the module and applying the module after update to a new session while applying a module before update to the existing session that the module before update is currently processing.

24. An operating method of a communication apparatus including a set of a plurality of modules that perform protocol processing, comprising the steps of:
individually retaining predetermined meta-information of respective modules;
determining the packet processing order between the plurality of modules based on a packet to be processed and meta-information individually retained in the plurality of modules;
attaching the information concerning the determined packet processing order to the packet; and
allowing each module to determine a transmission destination of the packet based on the information concerning the packet execution order which has been attached to the packet.

25. The operating method according to claim 24, further comprising the steps of:
determining whether each module can process at least the header information of the packet based on the packet and meta-information individually retained in the respective modules;
identifying the modules that can process at least the header information of the packet and attaching to the packet information in which the identification information of the identified modules are sequentially connected as information indicating packet processing order; and
passing the packet to the next identified module according to the order that the information attached to the packet indicates so as to allow the module to perform processing of the packet.

26. The operating method according to claim 25, further comprising the steps of:
allowing the application software to perform communication via the plurality of modules by using a transmission application program interface (API) and reception application program interface (API) connected between the plurality of modules and non-modular application software; and
calling a mechanism for determining the packet processing order between the transmission API and plurality of modules.

27. The operating method according to claim 25, further comprising the steps of:
performing communication with a module repository in which the plurality of modules are stored;
retaining only the meta-information of the plurality of modules in a separated manner from the plurality of modules;
acquiring, when it has been determined that one module of the plurality of modules is needed for packet processing, the one module from the module repository; and
deleting a no longer required module from the communication apparatus.

28. The operating method according to claim 25, further comprising the steps of:
storing and retaining information of the packet processing order between the plurality of modules in a cache; and
searching information of the cache so as to determine the packet processing order between the plurality of modules.

29. The operating method according to claim 27, further comprising the steps of:
detecting, in the case where the module stored in the module repository is updated, the update of the module; and
acquiring a module after update at the time of update of the module and applying the module after update to a new session while applying a module before update to the existing session that the module before update is currently processing.

30. An operation program of a communication apparatus including a set of a plurality of modules that perform protocol processing, the program allowing the computer to execute the steps of:
individually retaining predetermined meta-information of respective modules;
determining the packet processing order between the plurality of modules based on a packet to be processed and meta-information individually retained in the plurality of modules;
attaching the information concerning the determined packet processing order to the packet; and
allowing each module to determine a transmission destination of the packet based on the information concerning the packet execution order which has been attached to the packet.

31. A communication apparatus, comprising:
a plurality of modules configured to perform protocol processing of a packet to be processed:
a retaining section configured to retain predetermined meta-information for each of the plurality of modules; and
a calculating section configured to calculate connection order of each of the plurality of modules used for the protocol processing of the packet based on the meta-information of the retaining section and data of the packet.
